(19) United States
(12) Patent Application Publication
(10) Pub. No.: US 2019/0394706 A1
(43) Pub. Date: Dec. 26, 2019

(54) CONFIGURABLE DISCOVERY REFERENCE SIGNAL PERIODICITY FOR NARROWBAND INTERNET-OF-THINGS IN UNLICENSED SPECTRUM

(71) Applicant: TELEFONAKTIEBOLAGET L M ERICSSON (PUBL), Stockholm (SE)

(72) Inventors: Mai-Anh Phan, Herzogenrath (DE); David Sugirtharaj, Lund (SE); Emma Wittenmark, Lund (SE); Oskar Drugge, Hjärup (SE); Olof Liberg, Stockholm (SE)

(21) Appl. No.: 16/015,189

(22) Filed: Jun. 22, 2018

(51) Int. Cl. H04W 48/10; H04J 11/00; H04W 52/02

(52) U.S. Cl. CPC H04W 48/10; H04J 2011/0096; H04W 52/0216; H04J 11/0073

(57) ABSTRACT

In certain embodiments, a method of operating a wireless communication device comprises receiving a narrowband secondary synchronization signal (NSSS) in a discovery reference signal (DRS), identifying a transformation applied to the NSSS, and determining a DRS periodicity based on the identified transformation.

### TECHNICAL FIELD

The disclosed subject matter relates generally to telecommunications. Certain embodiments relate more particularly to concepts such as long-term evolution (LTE), MulteFire, narrowband internet-of-things (NB-IoT), unlicensed spectrum, and discovery reference signals (DRSs).

### BACKGROUND

In some telecommunications systems, a radio access node transmits DRSs to allow wireless communication devices to identify cells and/or measure radio resources, among other things. Examples of such systems include Long Term Evolution (LTE) systems and MulteFire systems.

A typical DRS may comprise, e.g. a primary synchronization signal (PSS), a secondary synchronization signal (SSS), a cell-specific reference signal (CRS), and/or other information. Such a DRS may be transmitted periodically (e.g., within a periodic DRS window) and have a specified duration or dwell time. Wireless communication devices may therefore detect such a DRS according to a configured DRS periodicity.

The details and/or requirements of DRS implementation may vary according by context. For instance, DRS implementation may vary between a NB-IoT system and a non-NB-IoT system, or between a system operating in unlicensed spectrum (e.g., license assisted access (LAA) enabled LTE system, or a MulteFire system) and a system not operating in unlicensed spectrum. Consequently, there is a general need for effective DRS designs that address specific issues according to context.

### SUMMARY

In certain embodiments of the disclosed subject matter, a method of operating a wireless communication device comprises receiving a narrowband secondary synchronization signal (NSSS) in a discovery reference signal (DRS), identifying a transformation applied to the NSSS, and determining a DRS periodicity based on the identified transformation.

In certain related embodiments, identifying the transformation comprises identifying a phase shift of the NSSS. In some such embodiments, identifying the phase shift comprises determining the phase shift from among a predetermined number of candidate phase shift values, and wherein the DRS periodicity is determined from among a predetermined number of candidate DRS periodicities according to the determined phase shift. In some embodiments the predetermined number of candidate phase shift values is four and the predetermined number of candidate DRS periodicities is four.

In certain related embodiments, identifying the transformation comprises identifying an orthogonal cover code (OCC) applied to the NSSS. In some such embodiments, identifying the OCC comprises determining the OCC from among a predetermined number of candidate OCCs, and wherein the DRS periodicity is determined from among a predetermined number of candidate DRS periodicities according to the determined OCC. In some such embodiments the predetermined number of candidate OCCs is four and the predetermined number of candidate DRS periodicities is four.

In certain related embodiments, the method further comprises detecting a narrowband physical broadcast channel (NPBCH) within a same DRS period as the NSSS. In some such embodiments, the method further comprises identifying another transformation applied to the NSSS, and determining a redundancy version of the NPBCH according to the other transformation. In some such embodiments the transformation is a phase shift, and the other transformation is an orthogonal cover code (OCC). In certain alternative embodiments, the transformation is an orthogonal cover code (OCC) and the other transformation is a phase shift.

In certain related embodiments, the DRS is transmitted in unlicensed spectrum.

In certain embodiments of the disclosed subject matter, a wireless communication device comprises processing circuitry, memory and transceiver circuitry collectively configured to receive a narrowband secondary synchronization signal (NSSS) in a discovery reference signal (DRS), identify a transformation applied to the NSSS, and determine a DRS periodicity based on the identified transformation.

In certain related embodiments, the processing circuitry, memory and transceiver circuitry are collectively further configured to detect a narrowband physical broadcast channel (NPBCH) within a same DRS period as the NSSS. In some such embodiments the processing circuitry, memory and transceiver circuitry are collectively further configured to identify another transformation applied to the NSSS, and determine a redundancy version of the NPBCH according to the other transformation.

In certain related embodiments, the transformation is a phase shift or an orthogonal cover code (OCC).

In certain embodiments of the disclosed subject matter, a radio access node comprises processing circuitry, memory and transceiver circuitry collectively configured to determine a discovery reference signal (DRS) periodicity, apply a transformation to a narrowband secondary synchronization signal (NSSS) to be transmitted in a DRS, wherein the transformation corresponds to the determined DRS periodicity, and transmit the NSSS in the DRS. In some such embodiments, the transformation is a phase shift or an orthogonal cover code (OCC). In certain alternative embodiments, the processing circuitry, memory and transceiver circuitry are further collectively configured to apply another transformation to the NSSS, wherein the other transformation corresponds to a redundancy version of a narrowband physical broadcast channel (NPBCH) to be transmitted within a same DRS period as the NSSS. In some such embodiments, the transformation is a phase shift and the other transformation is an orthogonal cover code (OCC).

Certain embodiments of the disclosed subject matter are presented in recognition of shortcomings associated with conventional techniques and technologies, such as the following examples. For the designs currently under discussion within MFA, having a configurable DRS periodicity is regarded as beneficial. The benefit of having the DRS periodicity configurable is that depending on deployment, the overhead can be adjusted and expected latency can be adjusted to fit the needs of a specific deployment. However, for the UE to be able to utilize several transmissions of the NPBCH for reception, the periodicity of the DRS needs to be derived before starting NPBCH reception. One option is to fix the periodicity in the specification, which has the drawbacks of not providing flexible deployment options.

Certain embodiments of the disclosed embodiments may provide potential benefits compared to conventional techniques and technologies, such as the following examples.

By using the phases of the NSSS, the DRS periodicity can be made configurable, and still enables UEs to combine several instances of the NPBCH for improved performance. Knowing the DRS periodicity can save UE battery as the UE does not need multiple attempts to derive the DRS periodicity and timing, the used RV can be contained in the NSSS info. By enabling the DRS periodicity to be configurable, the system can be adjusted to fit for example different latency needs at a specific deployment.

### BRIEF DESCRIPTION OF THE DRAWINGS

The drawings illustrate selected embodiments of the disclosed subject matter. In the drawings, like reference labels denote like features.

FIG. (FIG.) 1 illustrates communication system according to an embodiment of the disclosed subject matter.

FIG. 2A illustrates a wireless communication device according to an embodiment of the disclosed subject matter.

FIG. 2B illustrates a wireless communication device according to another embodiment of the disclosed subject matter.

FIG. 3A illustrates a radio access node according to an embodiment of the disclosed subject matter.

FIG. 3B illustrates a radio access node according to another embodiment of the disclosed subject matter.

FIG. 4 illustrates a radio access node according to yet another embodiment of the disclosed subject matter.

FIG. 5 illustrates an example DRS structure according to some embodiments of the disclosed subject matter.

FIG. 6 illustrates an example of NPSS and NSSS performance.

FIGS. 7A and 7B illustrate examples of NPBCH performance.

FIG. 8 illustrates a method of operating a wireless communication device according to an embodiment of the disclosed subject matter.

FIG. 9 illustrates a method of operating a radio access node according to an embodiment of the disclosed subject matter.

### DETAILED DESCRIPTION

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the disclosed subject matter.

LTE defines radio frames consisting of ten equally sized subframes of 1 ms length. Each frame is identified by a System Frame Number (SFN). The SFN is used to control different transmission cycles that may have a period longer than one frame, such as paging. The SFN supports 2¹⁰=1024 values corresponding to 10.24 seconds.

The 8 most significant bits of the SFN are signaled in the Master Information Block (MIB). The 2 least significant bits are derived by decoding the Physical Broadcast Channel (PBCH). The PBCH is transmitted with a transmit time interval (TTI) of 40 ms. Within the PBCH TTI, 4 different redundancy versions (RVs) of the PBCH are transmitted in SF#0 of each radio frame. Thus, one radio frame within the PBCH TTI can be identified by the RV. In each radio frame, SF#0 and SF#5 contain Secondary Synchronization Signal (SSS) and Primary Synchronization Signal (PSS) of 1 orthogonal frequency division multiplexing (OFDM) symbol length for frequency division duplexing (FDD), and in SF#0 and SF#4 for time division duplexing (TDD).

For NB-IoT, which supports single Physical Resource Block, 1-PRB (180 kHz) systems, coverage is extended by increasing the TTIs and increasing the number of repetitions. This results in an increased PBCH TTI of 640 ms, which is divided into eight blocks of 80 ms length. Each block is identified by one of 8 Code Subblock (CSB) versions, and in each block, the same CSB version is transmitted in SF#0 of each radio frame. Similarly, the narrowband primary synchronization signal (NPSS) and narrowband secondary synchronization signal (NSSS) are extended to 11 OFDM symbols, and thus occupy the data region of 1 subframe.

NPSS is transmitted in SF#5 in each radio frame, and NSSS is transmitted in SF#9 of every radio frame with even SFN. The NPSS/NSSS have a period of 80 ms and allow the UE to establish timing within this 80 ms period.

With the 8 CSB versions, it is possible to identify a block within the NPBCH TTI. Within the 80 ms block, NPSS provides 10 ms timing, and NSSS uses 4 different phases, which gives the 80 ms timing information.

As a consequence, 6 bits for SFN are derived from PBCH/NSSS/NPSS decoding (640 ms NPBCH TTI). The 4 MSBs of the SFN are transmitted in MIB-NB.

Due to the expansion in time, the 10-bit Hyper System Frame Number, also referred to as H-SFN or HFN, has been introduced to identify SFN wrap-arounds.

For NB-IoT in unlicensed spectrum (NB-IoT-U), which is currently being specified for MulteFire (MF) 1.1 for sub-1GHz bands in the US/EU/China, NB-IoT-U shall comply with FCC regulations (15.247) for the US. There are basically 3 design options.

A first option is Digital modulation (DM). DM requires usage of 3 PRBs, which diverts from the original 1-PRB design.

A second option is frequency hopping spread spectrum (FHSS). FHSS requires the system to hop over at least N=50 frequencies if the bandwidth is <250 kHz. The system stays on each frequency for a specific time referred to as the dwell time. The dwell time is assumed to be a multiple of a radio frame. A frequency hopping cycle (FH cycle) implies that each of the N hopping frequencies is visited exactly once. Further, it is assumed that at least synchronization signals are transmitted on one or more known frequencies. These are referred to as anchor or discovery channels.

According to MulteFire contributions mf2018.088.00 & mf2018.067.00, for initial acquisition, a UE would only monitor the primary discovery channel, which only occurs every N frequency hops. Here, it is assumed that the P-Channel contains NPSS, NSSS, and NPBCH for one-shot acquisition.

A third option is a hybrid system. A hybrid system may assume DM for initial acquisition, and FH for data transmission/reception. The dwell time on each frequency depends on the design, but mainly depends on the NPSS/NSSS synchronization performance and potentially NPBCH performance and whether to aim for one-shot or accumulated acquisition. For the hybrid system, we consider only one discovery channel, which may be visited more often than just once per FH cycle (see e.g. mf2018.338.00).

For a DRS repetition factor of 2, the DRS periodicity is the FH cycle duration divided by a factor of 2. In some embodiments, the dwell duration is 20 ms, and the number of hopping positions is N=64, resulting in a FH cycle 64*20 ms=1280 ms.

With a DRS repetition factor of {1, 2, 4, 8, 16, etc.}, the DRS period would be {1280 ms, 640 ms, 320 ms, 160 ms, 80 ms}. If the FH cycle duration shall be fixed to 64*20 ms=1280 ms, the DRS transmission will puncture frequency hops.

For DRS period=1280 ms, the DRS repetition factor DRS_rep would be 1, and thus the number of frequency hops would be N=64−DRS_rep=63. For DRS period=320 ms, i.e the DRS repetition factor is 1280 ms/320 ms=4, meaning that 4 hops within the FH cycle would be punctured out, i.e. N=(64−DRS rep)=60.

For DRS_rep=2, N=62 hopping frequencies. For DRS_rep=4, N=60 hopping frequencies. And for DRS rep=8, N=56 hopping frequencies.

In some NB-IoT designs, a narrowband secondary NSSS encodes timing information by encoding the NSSS with different phase shifts. Depending on the frequency hopping and frame-structure design of NB-IoT-U, timing information in NSSS may not be needed, and the phase shifts used for NSSS are free to use for other purposes.

There are four phase shifts for NSSS defined for NB-IoT-U, and these can be used to convey DRS periodicity information to the UE. It is deemed sufficient with four periodicities to get a flexible NB-IoT-U system.

The user equipment (UE) steps are for such a process may be as follows. Detect an NSSS (step 1), determine the phase shift of the NSSS (step 2), and determine the DRS periodicity based on the phase shift (step 3). Such a process may further comprise searching or detecting and reading a broadcast channel (e.g. NPBCH) for further system information regarding the cell access such as barring and random access information (step 4).

To help the UE with the NPBCH decoding process, 4 cover codes (CC) could additionally be used and associated with the 8 redundancy version (RV) of the NPBCH (step 5). In one example, a CC 0 is associated with RV mod4=0, a CC 1 is associated with RV mod 4=1. A CC 2 is associated with RV mod=2, and a CC 3 is associated with RV mod 4. Instead of 8 decoding hypothesis, the UE only has to try 2 hypotheses. Alternatively, in step 2, the 4 cover codes can be used instead of the phase shift to signal the 4 DRS periodicities, and in step 5, the phase shift can be used instead of the CC.

As indicated by the foregoing, in certain embodiments a network node (e.g., an eNB or gNB) transmits an NSSS signal, using the phase of the NSSS to convey to the UE the periodicity of the DRS. A related solution from a UE perspective is to receive the NSSS, determine the DRS periodicity from the NSSS phase shift information, and perform NPBCH reception with the possibility to combine over several instances of the NPBCH.

A NB-IoT NSSS for a cell can be determined by a Zadoff Chu sequence, 4 cover codes and 4 phase shifts. This allows for 504 PCIDs determined by the ZC sequence and the 4 cover codes.

In the unlicensed operation using FH, the NSSS along with the NPSS occurs once every N_DRS hops on the discovery channel on a specified frequency, as in the following example.
FH cycle
   Tdwell=20 ms
      N_DRS=16 hops
         ≤DRS period=320 ms

Because the NSSS periodicity is 320 ms, the 4 phase shifts used to determine the timing within 80 ms is not required. In certain embodiments described herein, the 4 values of the phase shift are used to determine the DRS periodicity (DRS period=N_DRS*20 ms).

After determining the DRS periodicity, the UE continues to decode the NPBCH which can use the same or a different format as existing systems.

The described embodiments may be implemented in any appropriate type of communication system supporting any suitable communication standards and using any suitable components. As one example, certain embodiments may be implemented in a communication system such as that illustrated in FIG. 1. Although certain embodiments are described with respect to LTE systems and related terminology, the disclosed concepts are not limited to LTE or a 3GPP system. Additionally, although reference may be made to the term “cell”, the described concepts may also apply in other contexts, such as beams used in Fifth Generation (5G) systems, for instance.

Referring to FIG. 1, a communication system 100 comprises a plurality of wireless communication devices 105 (e.g., UEs, machine type communication [MTC]/machine-to-machine [M2M] UEs) and a plurality of radio access nodes 110 (e.g., eNodeBs or other base stations). Communication system 100 is organized into cells 115, which are connected to a core network 120 via corresponding radio access nodes 110. Radio access nodes 110 are capable of communicating with wireless communication devices 105 along with any additional elements suitable to support communication between wireless communication devices or between a wireless communication device and another communication device (such as a landline telephone).

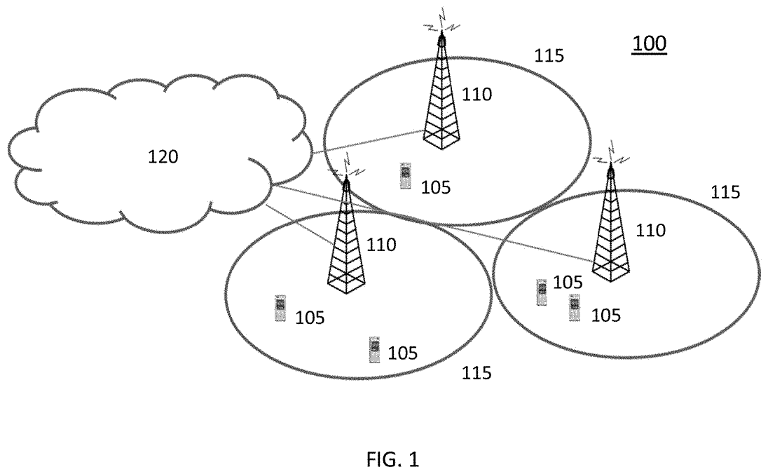

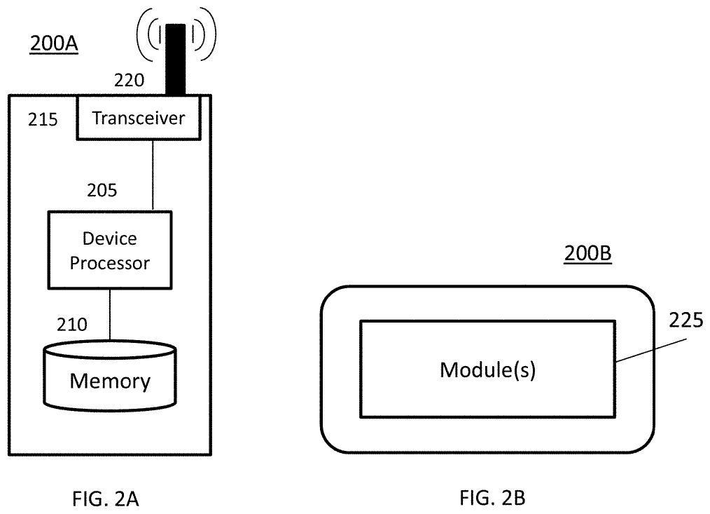

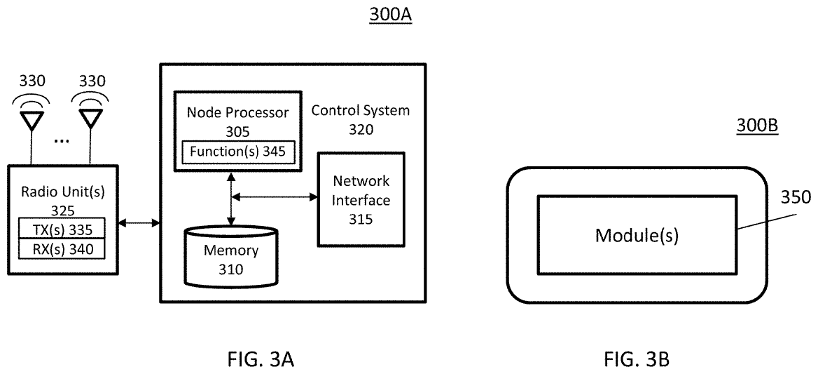

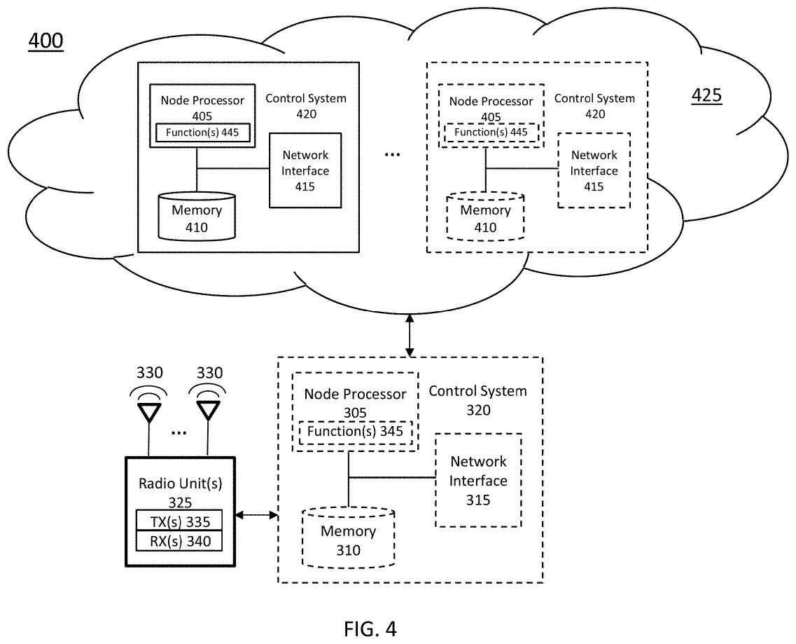

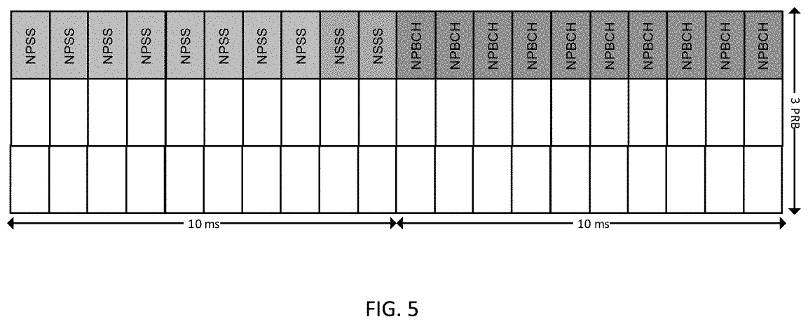

Although wireless communication devices 105 may represent communication devices that include any suitable combination of hardware and/or software, these wireless communication devices may, in certain embodiments, represent devices such as those illustrated in greater detail by FIGS. 2A and 2B. Similarly, although the illustrated radio access node may represent network nodes that include any suitable combination of hardware and/or software, these nodes may, in particular embodiments, represent devices such those illustrated in greater detail by FIGS. 3A, 3B and 4.

Referring to FIG. 2A, a wireless communication device 200A comprises a processor 205 (e.g., Central Processing Units [CPUs], Application Specific Integrated Circuits [ASICs], Field Programmable Gate Arrays [FPGAs], and/or the like), a memory 210, a transceiver 215, and an antenna 220. In certain embodiments, some or all of the functionality described as being provided by UEs, MTC or M2M devices, and/or any other types of wireless communication devices may be provided by the device processor executing instructions stored on a computer-readable medium, such as memory 210. Alternative embodiments may include additional components beyond those shown in FIG. 2A that may be responsible for providing certain aspects of the device's functionality, including any of the functionality described herein.

Referring to FIG. 2B, a wireless communication device 200B comprises at least one module 225 configured to perform one or more corresponding functions. Examples of such functions include various method steps or combinations of method steps as described herein with reference to wireless communication device(s). In general, a module may comprise any suitable combination of software and/or hardware configured to perform the corresponding function. For instance, in some embodiments a module comprises software configured to perform a corresponding function when executed on an associated platform, such as that illustrated in FIG. 2A.

Referring to FIG. 3A, a radio access node 300A comprises a control system 320 that comprises a node processor 305 (e.g., Central Processing Units (CPUs), Application Specific Integrated Circuits (ASICs), Field Programmable Gate Arrays (FPGAs), and/or the like), memory 310, and a network interface 315. In addition, radio access node 300A comprises at least one radio unit 325 comprising at least one transmitter 335 and at least one receiver coupled to at least one antenna 330. In some embodiments, radio unit 325 is external to control system 320 and connected to control system 320 via, e.g., a wired connection (e.g., an optical cable). However, in some other embodiments, radio unit 325 and potentially the antenna 330 are integrated together with control system 320. Node processor 305 operates to provide at least one function 345 of radio access node 300A as described herein. In some embodiments, the function(s) are implemented in software that is stored, e.g., in the memory 310 and executed by node processor 305.

In certain embodiments, some or all of the functionality described as being provided by a base station, a node B, an enodeB, and/or any other type of network node may be provided by node processor 305 executing instructions stored on a computer-readable medium, such as memory 310 shown in FIG. 3A. Alternative embodiments of radio access node 300 may comprise additional components to provide additional functionality, such as the functionality described herein and/or related supporting functionality.

Referring to FIG. 3B, a radio access node 300B comprises at least one module 350 configured to perform one or more corresponding functions. Examples of such functions include various method steps or combinations of method steps as described herein with reference to radio access node(s). In general, a module may comprise any suitable combination of software and/or hardware configured to perform the corresponding function. For instance, in some embodiments a module comprises software configured to perform a corresponding function when executed on an associated platform, such as that illustrated in FIG. 3A.

FIG. 4 is a block diagram that illustrates a virtualized radio access node 400 according to an embodiment of the disclosed subject matter. The concepts described in relation to FIG. 4 may be similarly applied to other types of network nodes. Further, other types of network nodes may have similar virtualized architectures. As used herein, the term “virtualized radio access node” refers to an implementation of a radio access node in which at least a portion of the functionality of the radio access node is implemented as a virtual component(s) (e.g., via a virtual machine(s) executing on a physical processing node(s) in a network(s)).

Referring to FIG. 4, radio access node 400 comprises control system 320 as described in relation to FIG. 3A.

Control system 320 is connected to one or more processing nodes 420 coupled to or included as part of a network(s) 425 via network interface 315. Each processing node 420 comprises one or more processors 405 (e.g., CPUs, ASICs, FPGAs, and/or the like), memory 410, and a network interface 415.

In this example, functions 345 of radio access node 300A described herein are implemented at the one or more processing nodes 420 or distributed across control system 320 and the one or more processing nodes 420 in any desired manner. In some embodiments, some or all of the functions 345 of radio access node 300A described herein are implemented as virtual components executed by one or more virtual machines implemented in a virtual environment(s) hosted by processing node(s) 420. As will be appreciated by one of ordinary skill in the art, additional signaling or communication between processing node(s) 420 and control system 320 is used in order to carry out at least some of the desired functions 345. As indicated by dotted lines, in some embodiments control system 320 may be omitted, in which case the radio unit(s) 325 communicate directly with the processing node(s) 420 via an appropriate network interface(s).

In some embodiments, a computer program comprises instructions which, when executed by at least one processor, causes at least one processor to carry out the functionality of a radio access node (e.g., radio access node 110 or 300A) or another node (e.g., processing node 420) implementing one or more of the functions of the radio access node in a virtual environment according to any of the embodiments described herein.

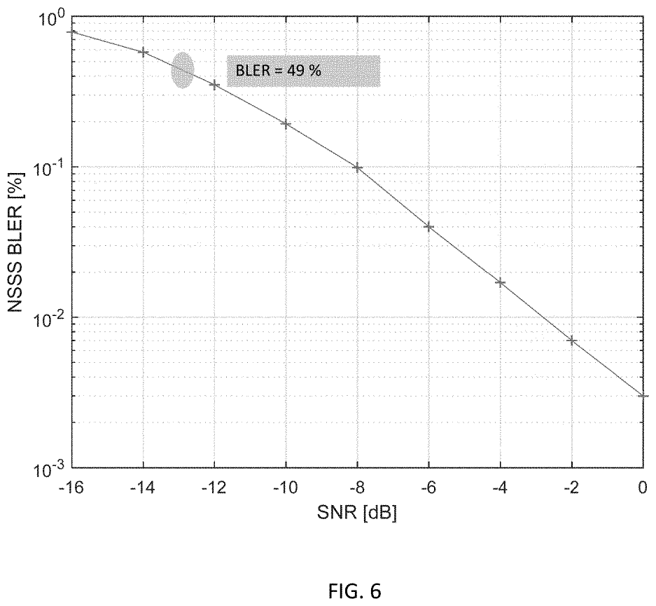

FIG. 5 illustrates an example DRS structure according to some embodiments of the disclosed subject matter. As illustrated in FIG. 5, the DRS structure comprises NPSS, NSSS and NPBCH. In certain embodiments described herein, once a wireless communication device detects the NSSS has been detected, it can thereafter try to decode the subsequent NPBCH.

The following description presents investigations of the performance of such a 20 ms DRS (NSSS, NPSS and NPBCH) signal when using Digital Modulation (DM) and mapping the NSSS, NPSS and NPBCH on one out of three available PRBs.

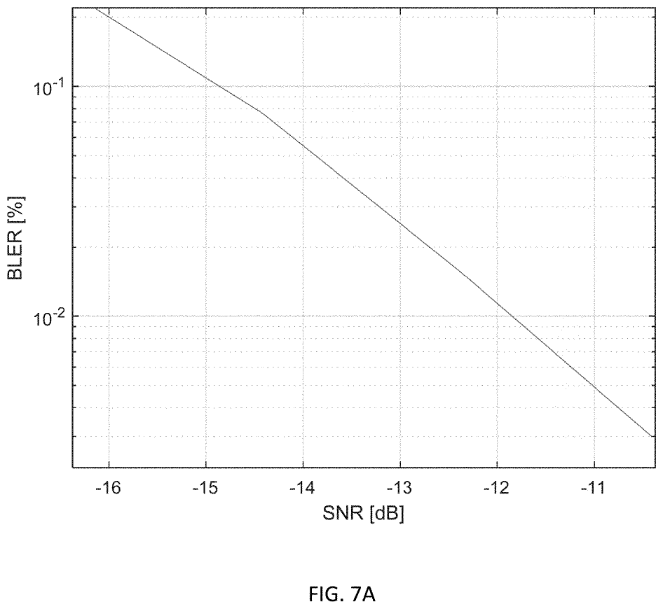

FIG. 6 illustrates an example of NPSS and NSSS performance. With a DM design the NPSS, NSSS synchronization must cope with a SINR operating point of −13.3 dB to support a MPL of 161 dB. FIG. 6 shows the single shot BLER performance.

The NPSS uses a length 8×14 cover code. The NSSS is extended to cover 14 OFDM symbols using a design that follows the following principles:

A 167 length ZC sequence is mapped over 14 OFDM symbols. A cyclic extension is used to generate a length 168 sequence.

126 ZC roots are used to generate 126 sequences.

4 different 168 length truncated Hadamard based cover codes is applied onto the ZC sequences to generate 504 sequences.

Each sequence is modulated with 4 different phases to generate 504×4 sequences.

As illustrated in FIG. 6, at a signal-to-noise ratio (SNR) of −13.3 dB the achieved BLER is 49%. After 4 independent attempts a device can be assumed to achieve a BLER<10%.

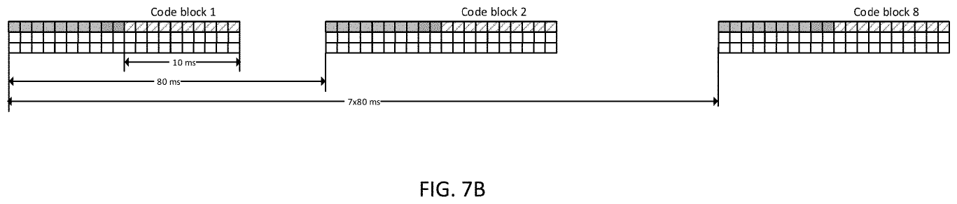

FIGS. 7A and 7B illustrate examples of NPBCH performance. With a DM design the NPBCH must cope with a SINR operating point of −13.3 dB to support a MPL of 161 dB.

This example shows the performance for a design with the following characteristics:

14 OFDM symbols/subframe

2 NRS ports, and 12 NRS per port.

3 dB NRS power boosting.

8 code blocks, each containing 10 repetitions.

FIG. 7A shows the BLER performance when we configure T_{period}=80 ms code block periodicity. As illustrated in FIG. 7A, at a SNR of −13.3 dB the achieved BLER is well below 10% after the acquisition of 8 code blocks as shown in FIG. 7B.

In certain embodiments, DRS design may have the following characteristics.

The NPSS may be extended to cover 14 OFDM symbols a use a length 8x14 cover code.

The NSSS may be extended to cover 14 OFDM symbols using a design that follows the following principles.
A 167 length ZC sequence is mapped over 14 OFDM symbols. A cyclic extension is used to generate a length 168 sequence.
126 ZC roots are used to generate 126 sequences.
4 different 168 length truncated Hadamard based cover codes is applied onto the ZC sequences to generate 504 sequences.
Each sequence is modulated with 4 different phases to generate 504×4sequences.

The NPBCH may be extended to cover 14 OFDM symbols using a design that follows the following principles.
Specify support for up to 2 NRS ports, with 12 NRS per port.
Specify support for up to 3 dB NRS power boosting.
The NPBCH is encoded into 8 code blocks, each containing 10 repetitions and mapped to 10 consecutive subframes.

In some embodiments, a DRS may also be designed according to the following.

The NPSS may be extended to cover 14 OFDM symbols a use a length 8×14 cover code.

The NSSS may be extended to cover 14 OFDM symbols using a design according to the following principles.
A 167 length ZC sequence is mapped over 14 OFDM symbols. A cyclic extension is used to generate a length 168 sequence.
126 ZC roots are used to generate 126 sequences.
4 different 168 length truncated Hadamard based cover codes is applied onto the ZC sequences to generate 504 sequences.
Each sequence is modulated with 4 different phases to generate 504x4 sequences.

The NPBCH may be extended to cover 14 OFDM symbols using a design according to the following.
Specify support for up to 2 NRS ports, with 12 NRS per port.
Specify support for up to 3 dB NRS power boosting.
The NPBCH is encoded into 8 code blocks, each containing 10 repetitions and mapped to 10 consecutive subframes.

In some embodiments, total initial NPSS, NSSS, NPBCH acquisition time may be defined in relation to one or more of the following characteristics.

If the NPSS, NSSS and NPBCH appears with a periodicity of T_{period} ms it has been shown that synchronization targeting 10% BLER can be achieved after roughly Tₜₒₜ=5×T_{period}+8×T_{period} ms.
Assuming T_{period}=80 ms gives Tₜₒₜ=1.04 s
Assuming T_{period}=160 ms gives Tₜₒₜ=2.08 s
Assuming T_{period}=320 ms gives Tₜₒₜ=4.16 s
Assuming T_{period}=640 ms gives Tₜₒₜ=8.32 s
Assuming T_{period}=1280 ms gives Tₜₒₜ=16.64 s

In general, supporting a configurable periodicity may offer a beneficial tradeoff between latency and NPSS, NSSS, NPBCH overhead.

An NPBCH design may have 8 code blocks, each containing 10 repetitions as illustrated in FIG. 5 with T_{period} configurable and selected from the set of 4 DRS periods.

The chosen T_{period} may be signaled using the NSSS phase or an OCC code, for instance.

In various embodiments as described herein, a 20 ms DRS structure can be used in a digital modulated system.

In certain embodiments, the NPSS is extended to cover 14 OFDM symbols and use a length 8×14 cover code.

In certain embodiments, the NSSS is extended to cover 14 OFDM symbols using a design according to the following.
A 167 length ZC sequence is mapped over 14 OFDM symbols. A cyclic extension is used to generate a length 168 sequence.
126 ZC roots are used to generate 126 sequences.
4 different 168 length truncated Hadamard based cover codes is applied onto the ZC sequences to generate 504 sequences.
Each sequence is modulated with 4 different phases to generate 504×4 sequences.

In some embodiments, the NPBCH is extended to cover 14 OFDM symbols using a design according to the following.
Specify support for up to 2 NRS ports, with 12 NRS per port.
Specify support for up to 3 dB NRS power boosting.
The NPBCH is encoded into 8 code blocks, each containing 10 repetitions and mapped to 10 consecutive subframes.

In some embodiments, an NPBCH comprises 8 code blocks, each containing 10 repetitions as shown in FIG. 5, with T_{period} configurable and selected from the set of 4 DRS periods. The chosen T_{period} can an be signaled using the NSSS phase or orthogonal cover code, for example.

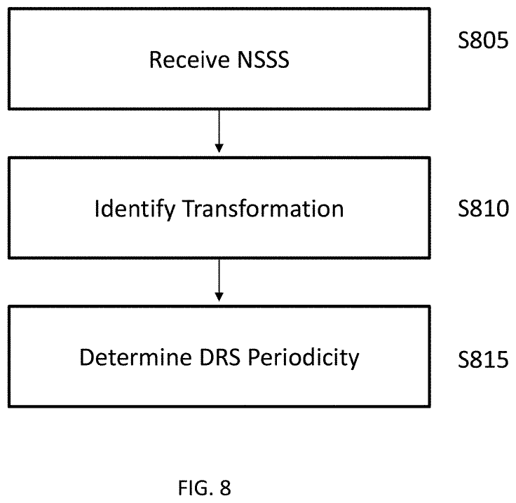

FIG. 8 illustrates a method of operating a wireless communication device according to an embodiment of the disclosed subject matter. The method could be performed, for instance, by a wireless communication device as described in relation to any of FIGS. 1-2 and 4. Such a wireless communication device could comprise processing circuitry, memory and transceiver circuitry collectively configured to perform the operations of the method, such as those described below.

Referring to FIG. 8, the method comprises receiving a narrowband secondary synchronization signal (NSSS) in a discovery reference signal (DRS) (S805), identifying a transformation applied to the NSSS (S810), and determining a DRS periodicity based on the identified transformation (S815).

The transformation may comprise, for instance, a phase shift of the NSSS. The phase shift may be determined from among a predetermined number of candidate phase shift values, and the DRS periodicity is determined from among a predetermined number of candidate DRS periodicities according to the determined phase shift. For instance, the predetermined number of candidate phase shift values may be four and the predetermined number of candidate DRS periodicities may be four. The four DRS periodicities could be selected from a set of five options as described herein, although they are not limited thereto.

In an alternative embodiment, the transformation may comprise an orthogonal cover code (OCC). The wireless communication device may, for instance, identify the OCC from among a predetermined number of candidate OCCs, and the DRS periodicity may be determined from among a predetermined number of candidate DRS periodicities according to the determined OCC. In some embodiments, the predetermined number of candidate OCCs is four and the predetermined number of candidate DRS periodicities is four.

In some embodiments, the method of FIG. 8 further comprises detecting a narrowband physical broadcast channel (NPBCH) within a same DRS period as the NSSS. The method may still further comprise identifying another transformation applied to the NSSS, and determining a redundancy version of the NPBCH according to the other transformation. In one example, the transformation is a phase shift, and the other transformation is an orthogonal cover code (OCC). In certain embodiments, the transformation is an orthogonal cover code (OCC) and the other transformation is a phase shift.

In the method of FIG. 8, as well as in other embodiments, the DRS may be transmitted in unlicensed spectrum. For instance, the DRS may be transmitted in an LAA enabled LTE system, a MulteFire system, or another type of system operating in unlicensed spectrum.

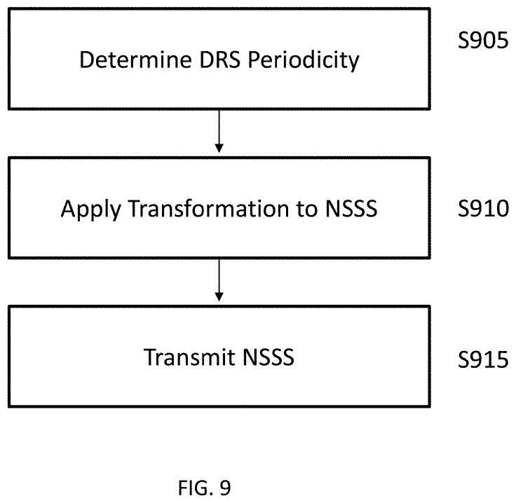

FIG. 9 illustrates a method of operating a radio access node according to an embodiment of the disclosed subject matter. The method could be performed, for instance, by a radio access node as described in relation to any of FIGS. 1 and 3-4. Such a wireless communication device could comprise processing circuitry, memory, transceiver circuitry, and/or other features collectively configured to perform the operations of the method, such as those described below.

Referring to FIG. 9, the method comprises determining a discovery reference signal (DRS) periodicity (S905), applying a transformation to a narrowband secondary synchronization signal (NSSS) to be transmitted in a DRS, wherein the transformation corresponds to the determined DRS periodicity (S910), and transmitting the NSSS in the DRS (S915). The transformation could be, for instance, a phase shift or an orthogonal cover code (OCC).

In some embodiments, the method further comprises applying another transformation to the NSSS, wherein the other transformation corresponds to a redundancy version of a narrowband physical broadcast channel (NPBCH) to be transmitted within a same DRS period as the NSSS. The transformation may be e.g. a phase shift and the other transformation is an orthogonal cover code (OCC).

In addition to the foregoing features, the method of FIG. 9 may also include features such as signal characteristics and transformations as described in relation to the method of FIG. 8. Moreover, various methods or apparatuses as described above, including those of FIGS. 8 and 9, may incorporate details such as DRS structures, timing information, protocols, block configurations, etc., as described above.

While the disclosed subject matter has been presented above with reference to various embodiments, it will be understood that various changes in form and details may be made to the described embodiments without departing from the overall scope of the disclosed subject matter.

1. A method of operating a wireless communication device, comprising:
receiving a narrowband secondary synchronization signal (NSSS) in a discovery reference signal (DRS);
identifying a transformation applied to the NSSS; and
determining a DRS periodicity based on the identified transformation.

2. The method of claim 1, wherein identifying the transformation comprises identifying a phase shift of the NSSS.

3. The method of claim 2, wherein identifying the phase shift comprises determining the phase shift from among a predetermined number of candidate phase shift values, and wherein the DRS periodicity is determined from among a predetermined number of candidate DRS periodicities according to the determined phase shift.

4. The method of claim 3, wherein the predetermined number of candidate phase shift values is four and the predetermined number of candidate DRS periodicities is four.

5. The method of claim 1, wherein identifying the transformation comprises identifying an orthogonal cover code (OCC) applied to the NSSS.

6. The method of claim 5, wherein identifying the OCC comprises determining the OCC from among a predetermined number of candidate OCCs, and wherein the DRS periodicity is determined from among a predetermined number of candidate DRS periodicities according to the determined OCC.

7. The method of claim 6, wherein the predetermined number of candidate OCCs is four and the predetermined number of candidate DRS periodicities is four.

8. The method of claim 1, further comprising detecting a narrowband physical broadcast channel (NPBCH) within a same DRS period as the NSSS.

9. The method of claim 8, further comprising:
identifying another transformation applied to the NSSS; and
determining a redundancy version of the NPBCH according to the other transformation.

10. The method of claim 9, wherein the transformation is a phase shift, and the other transformation is an orthogonal cover code (OCC).

11. The method of claim 9, wherein the transformation is an orthogonal cover code (OCC) and the other transformation is a phase shift.

12. The method of claim 1, wherein the DRS is transmitted in unlicensed spectrum.

13. A wireless communication device, comprising:
processing circuitry, memory and transceiver circuitry collectively configured to:
receive a narrowband secondary synchronization signal (NSSS) in a discovery reference signal (DRS);
identify a transformation applied to the NSSS; and
determine a DRS periodicity based on the identified transformation.

14. The wireless communication device of claim 13, wherein the processing circuitry, memory and transceiver circuitry are collectively further configured to detect a narrowband physical broadcast channel (NPBCH) within a same DRS period as the NSSS.

15. The wireless communication device of claim 14, wherein the processing circuitry, memory and transceiver circuitry are collectively further configured to:
identify another transformation applied to the NSSS; and
determine a redundancy version of the NPBCH according to the other transformation.

16. The wireless communication device of claim 13, wherein the transformation is a phase shift or an orthogonal cover code (OCC).

17. A radio access node, comprising:
processing circuitry, memory and transceiver circuitry collectively configured to:
determine a discovery reference signal (DRS) periodicity;
apply a transformation to a narrowband secondary synchronization signal (NSSS) to be transmitted in a DRS, wherein the transformation corresponds to the determined DRS periodicity; and
transmit the NSSS in the DRS.

18. The radio access node of claim 17, wherein the transformation is a phase shift or an orthogonal cover code (OCC).

19. The radio access node of claim 17, wherein the processing circuitry, memory and transceiver circuitry are further collectively configured to:
apply another transformation to the NSSS, wherein the other transformation corresponds to a redundancy version of a narrowband physical broadcast channel (NPBCH) to be transmitted within a same DRS period as the NSSS.

20. The radio access node of claim 19, wherein the transformation is a phase shift and the other transformation is an orthogonal cover code (OCC).
